(19) United States
(12) Patent Application Publication
(10) Pub. No.: US 2014/0053972 A1
(43) Pub. Date: Feb. 27, 2014

(54) STRETCH RELEASING PRESSURE-SENSITIVE ADHESIVE ARTICLES AND METHODS OF USING THE SAME

(71) Applicant: 3M INNOVATIVE PROPERTIES COMPANY, St. Paul, MN (US)

(72) Inventors: James L. Bries, Cottage Grove, MN (US); Margaret M. Sheridan, Woodbury, MN (US); Barbara K. Schmotter, Stillwater, MN (US)

(73) Assignee: 3M INNOVATIVE PROPERTIES COMPANY, St. Paul, MN (US)

(21) Appl. No.: 14/066,115

(22) Filed: Oct. 29, 2013

Related U.S. Application Data
(63) Continuation of application No. 11/609,727, filed on Dec. 12, 2006, now abandoned.

(51) Int. Cl. C09J 5/06; C09J 5/00

(52) U.S. Cl. CPC C09J 5/06; C09J 5/00
USPC 156/235; 156/60; 156/322

(57) ABSTRACT

A stretch releasing pressure-sensitive adhesive article that includes a backing that includes a layer of foam having a density of from about 7 pounds per cubic foot to about 15 pounds per cubic foot, a caliper of from about 0.01 inch to less than 0.020 inch, a first major surface and a second major surface opposite the first major surface, a first pressure-sensitive adhesive composition disposed on the first major surface of the layer of foam and in direct contact with the layer of foam. The article exhibits at least about 40% surface contact to a standardized textured surface.

### BACKGROUND

The present invention relates to forming and maintaining an adhesive bond between a stretch releasing pressure-sensitive adhesive article and a textured surface.

Over the years a number of backed and un-backed pressure-sensitive adhesive tapes that are removable from a substrate through stretching have been developed. These pressure-sensitive adhesive tapes are often referred to as stretch releasing pressure-sensitive adhesive articles. The nature, construction, and properties of various stretch releasing pressure-sensitive adhesive articles are described in the literature and in patents. U.S. Pat. No. 4,024,312 (Korpman), for example, discloses a highly conformable adhesive article that includes a highly extensible and elastic backing film laminated with an adhesive layer. The adhesive article is easily stretchable and may be removed from a surface by stretching the article lengthwise in a direction substantially parallel to the surface. German Patent No. 33 31 016 discloses a high elasticity, low plasticity adhesive film based on a thermoplastic rubber and tackifying resins in which the adhesive bond can be broken by stretching the adhesive film in the direction of the plane of the adhesive bond. U.S. Pat. No. 5,516,581 (Kreckel et al.) discloses a removable adhesive article having a highly extensible and substantially inelastic backing coated with a layer of pressure-sensitive adhesive and a non-adhesive pull tab to facilitate stretch removal. The adhesive article can be removed from most surfaces without damaging the substrate by grasping the non-adhesive pull tab and stretching the article in a direction substantially parallel to the surface of the substrate. U.S. Pat. No. 6,231,962 (Bries et al.) discloses a removable foam adhesive strip that includes a backing that includes a layer of polymeric foam and a pressure-sensitive adhesive layer coated on at least one surface of the backing. A commercially available stretch releasing adhesive article is sold under the trade designation COMMAND by 3M Company, St. Paul, Minn.

Stretch releasing pressure-sensitive adhesive articles are used to mount a variety of objects such as hooks, calendars, posters, and signs to various substrates including painted walls. In many of these applications, the user intends for the stretch releasing pressure-sensitive adhesive article to remain in position for an extended period of time.

Although many of the existing stretch releasing pressure-sensitive adhesive articles exhibit good adhesion to the relatively smooth surfaces of painted drywall and maintain good adhesion to painted drywall over long periods of time, they tend to form weak adhesive bonds to textured surfaces, in general, and the textured surfaces of plasticized vinyl substrates, in particular. It is inherently difficult to form and maintain a good adhesive bond to a textured surface. The peaks and valleys of the textured surface make it difficult to achieve a good degree of contact between the adhesive and the textured surface. As a result, when the adhesive of a stretch releasing pressure-sensitive adhesive article is applied to a textured surface, the adhesive is not in contact with a sufficient amount of surface area to form or maintain a good adhesive bond thereto. Heavily embossed textured vinyl wallpaper substrates are one example of a class of particularly challenging substrates. As a further complication, vinyl wallpaper is often plasticized. When an adhesive is in contact with a plasticizer, the plasticizer tends to migrate into the adhesive. Plasticizer migration tends to interfere with forming and maintaining good adhesive bonds.

Attempts have been made to address these issues. One attempt to improve the ability of an adhesive article to adhere to rough and irregular surfaces involved pretreating the foam backing by damaging (e.g., puncturing or cutting up) the backing and including a relatively thicker layer of pressure-sensitive adhesive composition in the construction. See, e.g., U.S. Pat. Nos. 6,280,840 and 6,004,665. One attempt to increase adhesion of a stretch releasing pressure-sensitive adhesive article to a plasticized vinyl substrate involved developing a specialized pressure-sensitive adhesive formulation. See WO 2005/059055. There remains a need to achieve a stretch releasing pressure-sensitive adhesive article that forms and maintains a good adhesive bond to textured surfaces, and in particular textured plasticized vinyl surfaces, over an extended period of time.

### SUMMARY

The invention features a stretch releasing pressure-sensitive adhesive article (e.g., a tape) that includes a backing that includes a continuous layer of foam having a density of from about 7 pounds per cubic foot to about 15 pounds per cubic foot, a caliper of from about 0.01 inch to less than 0.020 inch, a first major surface and a second major surface opposite the first major surface, a first layer of first pressure-sensitive adhesive composition disposed on the first major surface of the layer of foam and in direct contact with the foam, and a nontacky tab, the article exhibiting at least 40% surface contact when bonded to a standardized textured surface.

In another embodiment, the article further includes a second layer of pressure-sensitive adhesive composition disposed on the second major surface.

In one embodiment, the backing further includes a polymer film bonded to the second major surface of the layer of foam. In other embodiments, the article further includes a second layer of pressure-sensitive adhesive composition disposed on the polymer film. In some embodiments, the article further includes a release liner disposed on the second layer of pressure-sensitive adhesive composition.

In one embodiment, the article exhibits a static shear to a standardized textured surface of at least 30,000 minutes. In some embodiments, the article exhibits a static shear to a standardized textured surface of at least 60,000 minutes. In another embodiment, the article exhibits a static shear to a plasticized vinyl substrate of at least 30,000 minutes. In other embodiments, the article exhibits a static shear to a plasticized vinyl substrate of at least 50,000 minutes.

In other embodiments, the article exhibits at least 50% surface contact when bonded to a standardized textured surface. In another embodiment, the article exhibits at least 60% surface contact when bonded to a standardized textured surface. In still other embodiments, the article exhibits at least 70% surface contact when bonded to a standardized textured surface. In one embodiment, the article exhibits at least 60% surface contact when bonded to a standardized textured surface and a static shear of at least 30,000 minutes to a plasticized vinyl substrate.

In another embodiment, the foam backing has a density from about 7.5 pounds per cubic foot to no greater than 12.5 pounds per cubic foot. In some embodiments, the foam backing has a density from 7.5 pounds per cubic foot to 8.5 pounds per cubic foot.

In one embodiment, the ratio of the load at break of the article to the stretch debond force of the backing is at least 1.5:1. In another embodiment, the ratio of the load at break of the article to the stretch debond force of the backing is at least 2:1.

In some embodiments, the article further includes a first release liner disposed on the first layer of pressure-sensitive adhesive composition, and a second release liner disposed on the second layer of pressure-sensitive adhesive composition.

In other embodiments, the pressure-sensitive adhesive composition includes a block copolymer that includes styrene and a copolymer derived from nitrogen and alkyl(methyl)acrylate.

In another embodiment, the stretch releasing pressure-sensitive adhesive article includes a backing consisting of a continuous layer of foam having a density of from about 7 pounds per cubic foot to about 15 pounds per cubic foot, a caliper of from about 0.01 inch to less than 0.020 inch, a first major surface and a second major surface opposite the first major surface, and a first layer of film bonded to the first major surface of the layer of foam, a first layer of a first pressure-sensitive adhesive composition disposed on the second major surface of the layer of foam and in direct contact with the foam, and a nontacky tab, the first pressure-sensitive adhesive composition exhibiting at least 40% surface contact when bonded to a standardized textured surface.

In one embodiment, the stretch releasing pressure-sensitive adhesive article includes a backing consisting of a continuous layer of foam having a density of from about 7 pounds per cubic foot to about 15 pounds per cubic foot, a caliper of from about 0.01 inch to less than 0.020 inch, a first major surface and a second major surface opposite the first major surface, and a first layer of film bonded to the first major surface of the layer of foam, a first layer of first pressure-sensitive adhesive composition disposed on the second major surface of the layer of foam and in direct contact with the foam, and a nontacky tab, the first pressure-sensitive adhesive composition exhibiting at least 40% surface contact when bonded to a standardized textured surface. In one embodiment, the first pressure-sensitive adhesive composition includes a block copolymer that includes styrene and a copolymer derived from nitrogen and alkyl(methyl)acrylate.

In another aspect, the invention features a stretch releasing pressure-sensitive adhesive article that includes a backing that includes a continuous layer of foam, a first major surface and a second major surface opposite the first major surface, a first layer of first pressure-sensitive adhesive composition disposed on the first major surface of the layer of foam and in direct contact with the foam, and a nontacky tab, the article exhibiting at least 40% surface contact when bonded to a standardized textured surface and a static shear to the standardized textured surface of at least 30,000 minutes.

In other aspects, the invention features a method of bonding a stretch releasing pressure-sensitive adhesive article disclosed herein to a surface, the method including contacting a surface with the first layer of pressure-sensitive adhesive composition of the stretch releasing pressure-sensitive adhesive article, and applying pressure along the longitudinal extent of the backing. In one embodiment, the applying pressure includes positioning an edge, which may be a planar or curved edge, of a rigid applicator tool near the first end of the backing, and drawing the rigid applicator tool down the longitudinal extent of the backing toward the second end of the backing while maintaining contact between the rigid substrate and the backing and exerting a force against the backing sufficient to press the adhesive composition into intimate contact with the surface. In some embodiments, the surface is a textured surface that includes features and the force exerted against the backing is sufficient to press the adhesive composition into intimate contact with the features. In one embodiment, the surface exhibits a Ra value of at least 40 μm (micron), a Rq value of at least 40 μm, and a Rz value of at least 300 μm over a 12.7 mm (millimeter) by 12.7 mm area of the surface, as measured according to the Surface Roughness Test Method set forth below.

In another embodiment, the surface comprises a textured, plasticized vinyl surface.

In some embodiments, the method further includes heating at least one of the pressure-sensitive adhesive composition and the surface prior to contacting the surface with the pressure-sensitive adhesive composition.

In another embodiment, the method of bonding a stretch releasing pressure-sensitive adhesive article that includes a second layer of pressure-sensitive adhesive composition and a release liner disposed on the second layer of pressure-sensitive adhesive composition to a surface includes contacting the surface with the first layer of pressure-sensitive adhesive composition, applying pressure to the article along the length of the article, removing the release liner to expose the second layer of pressure-sensitive adhesive composition, and contacting the second layer of pressure-sensitive adhesive composition with an object.

In other embodiments, the method includes contacting the surface with a stretch releasing pressure-sensitive adhesive article that includes a pressure-sensitive adhesive composition, a first end, a second end and a longitudinal extent extending between the first end and the second end, positioning an edge of a rigid applicator tool near the first end of the article, and drawing the edge of the rigid applicator tool down the longitudinal extent of the article toward the second end of the article while maintaining contact between the edge of the rigid applicator tool and the article and exerting a force against the article sufficient to press the pressure-sensitive adhesive composition into intimate contact with the surface. In one embodiment, the surface is the surface of a textured plasticized vinyl substrate and exhibits a Ra value of at least 40 μm, a Rq value of at least 40 μm, and a Rz value of at least 300 μm over a 12.7 mm by 12.7 mm area of the surface.

In another embodiment, the method further includes heating at least one of the pressure-sensitive adhesive composition and the surface prior to contacting the surface with the pressure-sensitive adhesive composition.

The present invention features a stretch releasing pressure-sensitive adhesive article that is conformable to a textured surface, forms and maintains good adhesion to the textured surface, and is cleanly removable from the textured surface through stretching without damaging the surface. The stretch releasing pressure-sensitive adhesive article can also be constructed using backing materials that exhibit good strength in the machine direction, the cross-machine direction or both, such that it can be stretched in such a direction without breaking.

The present invention also features a stretch releasing pressure-sensitive adhesive article that exhibits good adhesion to plasticized vinyl substrates.

The present invention also features a method of achieving improved surface contact between the stretch releasing pressure-sensitive adhesive construction and a textured surface.

Other features and advantages will be apparent from the following description of the drawings and the preferred embodiments, and from the claims.

### GLOSSARY

In reference to the invention, these terms have the meanings set forth below:

The term “textured surface” means any surface that includes visible or tactile surface roughness in the form of three dimensional features including protrusions (e.g., peaks), indentations (e.g., valleys and gorges), irregularities and combinations thereof.

The term “standardized textured surface” means a surface that exhibits a Ra value of at least 40 μm (micron), a Rq value of at least 40 μm, and a Rz value of at least 300 μm over a 12.7 mm (millimeter) by 12.7 mm area of the surface, as measured according to the Surface Roughness Test Method set forth below.

The term “plasticized” means the presence of plasticizer.

### BRIEF DESCRIPTION OF THE DRAWINGS

FIG. 1 is a top plan view of a stretch releasing pressure-sensitive adhesive article with a nontacky tab.

FIG. 2 is a sectional side view of the stretch releasing pressure-sensitive adhesive article of FIG. 1.

FIG. 3A is a sectional side view of the stretch releasing pressure-sensitive adhesive article of FIG. 2 adhered to a substrate.

FIG. 3B is a sectional side view of a partially stretched article of FIG. 3A.

FIG. 3C is a sectional side view of a further stretched article of FIG. 3B.

FIG. 4 is a sectional side view of a stretch releasing pressure-sensitive adhesive article according to another embodiment.

FIG. 5 is a sectional side view of a stretch releasing pressure-sensitive adhesive article according to another embodiment adhered to two substrates.

FIG. 6A is a front plan view of an end of a rigid plate pressed against a pressure-sensitive adhesive article that is in contact with a wall surface.

FIGS. 6B and 6C are schematic side views of the movement of the rigid plate of FIG. 6A against the stretch releasing pressure-sensitive adhesive article.

FIG. 7 is a topographical map of a first vinyl wallpaper.

FIG. 8 is a topographical map of a second vinyl wallpaper.

FIG. 9 is a topographical map of a third vinyl wallpaper.

FIG. 10 is a topographical map of a fourth vinyl wallpaper.

### DETAILED DESCRIPTION

The present inventors have made the surprising discovery that stretch releasing pressure-sensitive adhesive articles that include a pressure-sensitive adhesive composition in direct contact with a foam substrate having a density of from about 7 pounds per cubic foot (pcf) to about 15 pcf and a caliper of from about 0.01 inch to less than 0.020 inch, when bonded to a standardized textured substrate, achieve an extent of surface contact with the textured surface such that the article forms good adhesion to a standardized textured surface and maintains such adhesion until removed from the substrate through stretching. The article also is cleanly removable from the surface through stretching and does not break during stretching. Preferably the article is cleanly removable from the surface such that the surface is substantially free of, or even free of adhesive residue and substantially free of, or even free of damage. In some embodiments, the article also forms and maintains good adhesion to textured plasticized vinyl substrates.

Textured surfaces can be characterized using a variety of methods. One useful method of characterizing the surface topography of a textured surface includes utilizing a stylus profilometer. A profilometer can provide measurements that are used directly or indirectly to determine a variety of roughness parameters including Ra, Rq, and Rz, where Ra, the average roughness over the entire measured sample area, Rq, the root mean square roughness over the entire measured sample area, and Rz, the average of the ten greatest peak to valley separations over the entire measured sample area, are calculated as set forth in ASME B46.1-2002, which is entitled, “Surface Texture (Surface Roughness, Waviness and Lay),” and incorporated herein.

The present inventors have determined that some painted walls have a Ra of from about 5.6 μm to about 22 μm, a Rq of from about 7.1 μm to about 27 μm, and a Rz of from about 60 μm to about 169 μm. Smooth glass surfaces have been found to have a Ra of about 0.3 μm, a Rq of about 0.5 μm, and a Rz of about 3.5 μm. Textured vinyl wallpaper has been found to have Ra values of from about 24 μm to about 80 μm, Rq values of from about 29 μm to about 100 μm, and Rz values of from about 180 μm to about 450 μm.

The stretch releasing pressure-sensitive adhesive article preferably exhibits good adhesion to a variety of surfaces including, e.g., textured surfaces exhibiting a Ra of greater than about 20 μm, greater than about 25 μm, or even greater than about 40 μm, less than about 100 μm, less than about 90 μm, or even less than about 80 μm, a Rq of greater than about 30 μm, greater than about 40 μm, or even greater than about 50 μm, less than about 120 μm, less than about 100 μm, or even less than about 90 μm, and a Rz of greater than about 175 μm, greater than about 200 μm, or even greater than about 300 μm, less than about 500 μm, less than about 450 μm, or even less than about 400 μm.

The degree of contact the pressure-sensitive adhesive of a stretch releasing pressure-sensitive adhesive article achieves with the surface of a substrate impacts the ability of the stretch releasing pressure-sensitive adhesive article to form and maintain a bond to the substrate. The stretch releasing pressure-sensitive adhesive article exhibits a good degree of surface contact to textured surfaces, preferably at least about 40%, at least about 50%, at least about 60%, or even at least about 70% surface contact to a standardized textured surface.

In some embodiments the stretch releasing pressure-sensitive adhesive article is well suited to forming and maintaining a bond to plasticized vinyl substrates. Plasticized vinyl substrates include plasticizer in varying amounts including, e.g., greater than 1% by weight, at least about 5% by weight, at least about 10% by weight, at least about 20% by weight, or even at least about 30% by weight.

The stretch releasing pressure-sensitive adhesive article also maintains a strong adhesive bond to a textured surface. One measure of the strength of the bond formed between the stretch releasing pressure-sensitive adhesive article and a substrate is static shear. The stretch releasing pressure-sensitive adhesive article preferably exhibits static shear to a textured surface of at least 20,000 minutes, at least 30,000 minutes, at least 50,000 minutes, or even at least 60,000 minutes. In some embodiments, the stretch releasing pressure-sensitive adhesive article exhibits a static shear to a plasticized vinyl substrate (including a textured vinyl substrate) of at least 20,000 minutes, at least 30,000 minutes, at least 50,000 minutes, or even at least 60,000 minutes.

The stretch releasing pressure-sensitive adhesive article releases from a substrate through stretching. One measure of the stretch releasing property of the stretch releasing pressure-sensitive adhesive article is the ratio of the force of the load at break of the backing of the stretch releasing pressure-sensitive adhesive article to the stretch debond force of the stretch releasing pressure-sensitive adhesive article, which preferably is at least 1.5:1, at least about 1.8:1, at least about 2:1, or even at least about 3:1.

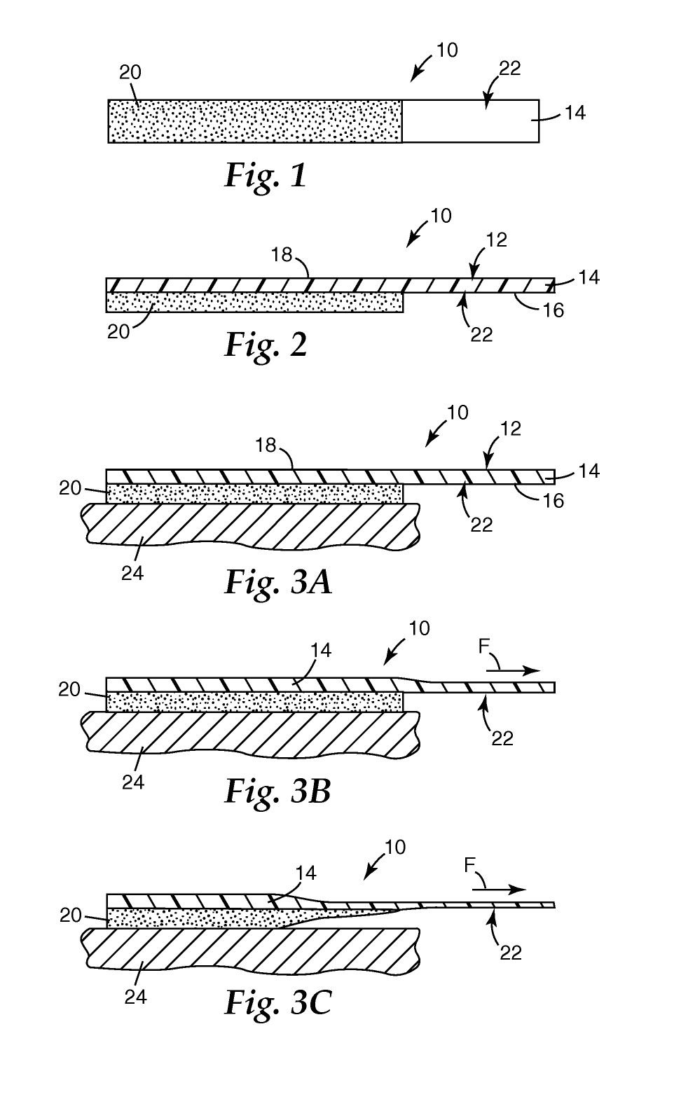

FIGS. 1 and 2 illustrate a stretch releasing pressure-sensitive adhesive article 10 that includes a backing 12 that includes a layer of foam 14 having a first major surface 16 and a second major surface 18, and a layer of a first pressure-sensitive adhesive composition 20 disposed directly on the first major surface 16 of the foam layer such that the first pressure-sensitive adhesive composition 20 is in direct contact with the foam layer 14. The stretch releasing pressure-sensitive adhesive article 10 also includes a nontacky tab 22 to assist in the removal of the stretch releasing pressure-sensitive adhesive article 10. In use, the stretch releasing pressure-sensitive adhesive article 10 is attached to a surface 24 through the layer of pressure-sensitive adhesive composition 20, as illustrated in FIG. 3A.

The stretch releasing pressure-sensitive adhesive article 10 can then be removed from the surface 24 by gripping the tab 22 of the pressure-sensitive adhesive article 10 and pulling on the tab, to stretch the article 10. A schematic illustration of a method of debonding the stretch releasing pressure-sensitive adhesive article 10 from the substrate 24 (i.e., removal by stretching) is shown in FIGS. 3A-C. FIG. 3A shows a stretch releasing pressure-sensitive adhesive article 10 bonded to a substrate 24. A force (F) is applied to the article 10 in a direction substantially parallel to the surface of the substrate. The bonded structure exhibits a relatively high initial resistance to shearing stress. When sufficient force is applied to overcome this resistance, the backing begins to deform as illustrated in FIG. 3B. In FIG. 3C the backing yields while the adhesive elongates and releases from the substrate 24. The stretching angle of the stretch releasing pressure-sensitive adhesive article 10 is usually from the direction substantially parallel to the surface of stretch releasing pressure-sensitive adhesive article 10 to an angle of no greater than about 35 degrees, no greater than about 30 degrees, or even no greater than about 10 degrees from the substrate surface.

### Backing

The backing of the stretch releasing pressure-sensitive adhesive article elongates when stretched in the lengthwise direction and is highly extensible. The term “highly extensible” as used herein means that when the backing is stretched in the lengthwise direction, an elongation of at least about 150% is achieved based on the original length. The backing preferably is capable of achieving an elongation of from about 50% to about 1,200%, from about 150% to about 700%, or even from about 350% to about 700%. The backing includes at least one layer of foam and optionally at least one layer of film. Examples of suitable backings include a single layer of foam and a composite that includes a layer of film bonded to a layer of foam.

Foam Layer

The foam layer of the backing of the stretch releasing pressure-sensitive adhesive article is conformable to a textured surface and assists in increasing the degree of surface contact between the pressure-sensitive adhesive composition disposed thereon and the textured surface. Preferably the foam exhibits a density of at least about 4 pounds per cubic foot (pcf), at least about 6 pcf, greater than about 7 pcf, or even greater than about 7.5 pcf, less than 15 pcf, no greater than about 13 pcf, or even no greater than about 12.5 pcf. Useful foam layers also have a caliper (i.e., thickness) greater than about 0.008 inch, greater than about 0.010 inch, greater than about 0.012 inch, less than about 0.022 inch, less than about 0.020 inch, less than about 0.018 inch, or even no greater than about 0.015 inch. The foam preferably is capable of achieving from about 50% to about 600% elongation. The layer of foam preferably exhibits an elongation at break that is sufficiently high such that the substrate is not ruptured prior to removal of the pressure-sensitive adhesive article from the surface to which the article is adhered.

In some embodiments, the foam layer is a single layer of foam or includes multiple layers of foam, each layer of foam having the same or different properties including, e.g., density, thickness, % elongation, breaking strength, and combinations thereof.

The layer of foam can be prepared from a variety of thermoplastic polymers including, e.g., polyolefins (e.g., polyethylene including, e.g., high density polyethylene, low density polyethylene, linear low density polyethylene, and linear ultra low density polyethylene), polypropylene, and polybutylenes; vinyl copolymers (e.g., polyvinyl chlorides, plasticized and unplasticized polyvinyl chlorides, and polyvinyl acetates); olefinic copolymers including, e.g., ethylene/methacrylate copolymers, ethylene/vinyl acetate copolymers, acrylonitrile-butadiene-styrene copolymers, and ethylene/propylene copolymers; acrylic polymers and copolymers; polyurethanes; and combinations thereof. Suitable blends also include, e.g., blends of thermoplastic polymers, elastomeric polymers, and combinations thereof including, e.g., polypropylene/polyethylene, polyurethane/polyolefin, polyurethane/polycarbonate, and polyurethane/polyester. Useful polyethylene vinyl acetate copolymer foams are available under the VOLEXTRA and VOLARA series of trade designations from Voltek, Division of Sekisui America Corporation (Lawrence, Mass.).

Film Layer

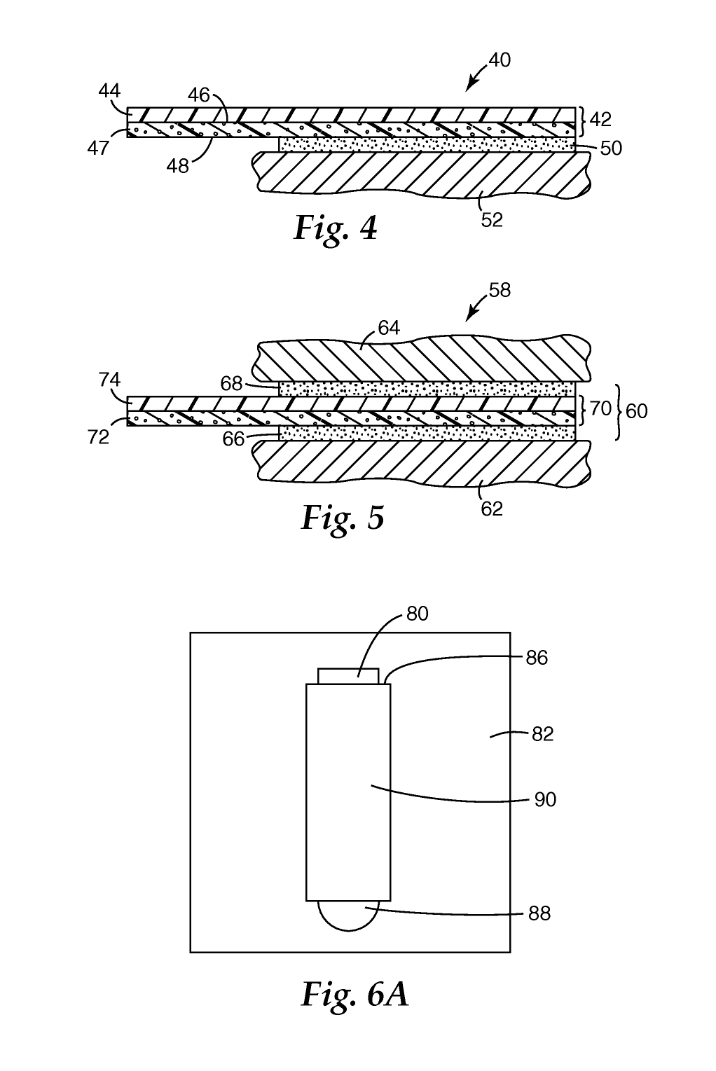

The backing of the stretch releasing pressure-sensitive adhesive article optionally includes at least one layer of a highly extensible polymer film in addition to the layer of foam. The polymer film is disposed on a major surface of the layer of foam that is opposite the first pressure-sensitive adhesive composition. FIG. 4 illustrates a stretch releasing pressure-sensitive adhesive article 40 that includes a backing 42 that includes a layer of highly extensible polymer film 44 disposed on a major surface 46 of the foam layer 47 and a pressure-sensitive adhesive composition 50 disposed on the opposite major surface 48 of the foam layer 47. The stretch releasing pressure-sensitive adhesive article 40 is bonded to a substrate 52 through the pressure-sensitive adhesive composition 50.

Particularly useful polymer films have a lengthwise elongation at break of from about 50% to about 1,200%, from about 150% to about 700%, or even from about 350% to about 700%, and a Young's modulus of at least about 1,000 psi (about 6,894.7 KPa), at least about 2,500 psi (about 17,236.8 KPa), or even at least about 3,000 psi (about 20,684.1 KPa), no greater than about 72,500 psi (about 499,865.8 KPa), no greater than about 50,000 psi (about 344,735 KPa), or even from about 5,000 psi to about 30,000 psi (about 34,473.5 KPa to 206,841 KPa). The polymer film preferably is capable of achieving the desired elongation at break in at least one of the machine direction and the cross direction of the film. The polymer film preferably exhibits an elongation at break that is sufficiently high such that the substrate is not ruptured prior to removal of the pressure-sensitive adhesive article from the surface to which the article is adhered.

Suitable films are formed from a variety of thermoplastic polymers including, e.g., polyolefins (e.g., polyethylene including, e.g., high density polyethylene, low density polyethylene, linear low density polyethylene, and linear ultra low density polyethylene), polypropylene, and polybutylenes; vinyl copolymers (e.g., polyvinyl chlorides, plasticized and unplasticized polyvinyl chlorides, and polyvinyl acetates); olefinic copolymers including, e.g., ethylene/methacrylate copolymers, ethylene/vinyl acetate copolymers, acrylonitrile-butadiene-styrene copolymers, and ethylene/propylene copolymers; acrylic polymers and copolymers; polyurethanes; and combinations thereof. Suitable blends also include, e.g., blends of thermoplastic polymers, elastomeric polymers, and combinations thereof including, e.g., polypropylene/polyethylene, polyurethane/polyolefin, polyurethane/polycarbonate, and polyurethane/polyester.

In some embodiments the highly extensible polymer film is in the form of a multilayer film. The polymer film can be in a variety of forms including, e.g., a single-layer or multilayer film, a porous film, and combinations thereof. The polymer film may also be a filled material such as filled film (e.g., calcium carbonate filled polyolefin). The polymer film can be a continuous layer or a discontinuous layer.

Multilayer polymer films are preferably integrally bonded to one another in the form of a composite film, a laminate film, and combinations thereof. The polymer films can be made integral to one another using any suitable method including, e.g., co-molding, coextruding, extrusion coating, joining through an adhesive, joining under pressure, joining under heat, and combinations thereof.

The polymer film preferably has a thickness of from about 0.4 mils to about 10 mils, or even from about 0.4 mils to about 6 mils.

Useful commercially available thermoplastic polymer films include, e.g., metallocene catalyzed linear low density polyethylene films available under the XMAX series of trade designations and linear low density polyethylene films available under the MAXILENE series of trade designations (e.g., MAXILENE 200) both of which are available from Pliant Corporation (Chippewa Falls, Wis.).

The film layer can be bonded to the layer of foam using any suitable mechanism including, e.g., coextruding the film and the foam layer, co-molding, extrusion coating, joining through an adhesive composition, joining under pressure, joining under heat, and combinations thereof. Useful adhesive compositions for bonding a film layer to the foam layer include the adhesive compositions set forth below.

### The Pressure-Sensitive Adhesive Composition

The First Pressure-Sensitive Adhesive Composition

The layer of pressure-sensitive adhesive composition disposed on the first major surface of the backing is any suitable pressure-sensitive adhesive composition. Preferred pressure-sensitive adhesive compositions exhibit good wet out to a textured surface. Particularly useful pressure-sensitive adhesive compositions exhibit a 180° peel force of from about 4 N/dm to about 200 N/dm, or even from about 25 N/dm to about 100 N/dm measured according to PSTC-1 and PSTC-3 and ASTM D903-83 at a peel rate of 12.7 cm/min.

Useful classes of pressure-sensitive adhesive compositions include, e.g., tackified rubber-based adhesives, such as natural rubber; olefins; silicones including, e.g., silicone polyamides and silicone polyureas; synthetic rubber adhesives such as polyisoprene, polybutadiene, and styrene-isoprene-styrene, styrene-ethylene-butylene-styrene and styrene-butadiene-styrene block copolymers, and other synthetic elastomers; and tackified or untackified acrylic adhesives such as copolymers of isooctylacrylate and acrylic acid, which can be polymerized by radiation, solution, suspension, emulsion techniques, and combinations thereof. Suitable pressure-sensitive adhesive compositions are described, e.g., in WO 2005/059055 and incorporated herein.

One useful pressure-sensitive adhesive composition includes a first portion that includes any suitable pressure-sensitive adhesive composition and a second portion that includes a nitrogen-containing vinyl monomer. Useful pressure-sensitive adhesive compositions that are suitable as the first portion of the pressure-sensitive adhesive composition include, e.g., the classes of pressure-sensitive adhesive compositions described above, as well as those pressure-sensitive adhesive compositions described in U.S. Pat. Nos. 6,569,521, 6,403,206, 6,231,962, 6,001,471 and 5,516,581, all of which are incorporated herein. One particularly useful pressure-sensitive adhesive for the first portion of the blend includes a styrene-based block copolymer. Examples of useful styrene-based block copolymers include styrene-isoprene block copolymer, styrene-butadiene block copolymer, styrene-ethylene-propylene block copolymer and styrene-ethylene-butylene block copolymer. The first portion optionally includes a tackifying agent. Suitable tackifying agents include, e.g., rosin resin, rosin ester resin, hydrogenated rosin ester resin, terpene resin, terpene phenol resin, hydrogenated terpene resin, petroleum resin, hydrogenated petroleum resin, chroman resin, styrene resin, modified styrene resin, xylene resin, epoxy resin and combinations thereof.

The first portion also optionally includes other additives including, e.g., softening agents, anti-aging agents and ultraviolet absorbents. Examples of useful softening agents include paraffin-based, naphthalene-based and phthalic acid ester-based softening agents. Examples of useful anti-aging agents include hindered phenol-based and hindered amine-based antioxidants.

The second portion of the pressure-sensitive adhesive composition is a nitrogen-containing vinyl monomer, examples of which include nitrogen-containing (meth) acrylic copolymers including, e.g., copolymers of an alkyl (meth)acrylate and nitrogen-containing vinyl monomers. Copolymers of an alkyl (meth)acrylate and a nitrogen-containing vinyl monomer can be prepared by copolymerizing an alkyl (meth)acrylate and a nitrogen-containing vinyl monomer at various mixing ratios including, e.g., from about 45 parts by weight to about 99.9 parts by weight of an alkyl (meth)acrylate and from about 0.1 parts by weight to about 20 parts by weight of a nitrogen-containing vinyl monomer. The nitrogen-containing (meth) acrylic copolymer can be grafted with from 0 to about 20 parts by weight of a polystyrene having a glass transition point of from about 20° C. to 250° C. and a weight average molecular weight of from about 2,000 to about 500,000, as measured by gel permeation chromatography, and optionally from about 0.1 parts by weight to about 5 parts by weight of a vinyl monomer having a reactive functional group on the side chain.

Particularly useful alkyl (meth)acrylates include (meth) acrylic acid esters of an alkyl group having from about 1 to about 11 carbon atoms. Examples of such (meth) acrylic acid esters include methyl ester of (meth) acrylic acid, ethyl ester of (meth) acrylic acid, butyl ester of (meth) acrylic acid, 2-methylbutyl ester of (meth) acrylic acid, t-butyl ester of (meth) acrylic acid, 2-ethylhexyl ester of (meth) acrylic acid, isooctyl ester of (meth) acrylic acid, cyclohexyl ester of (meth) acrylic acid and isobornyl ester of (meth) acrylic acid, and combinations thereof.

The nitrogen-containing vinyl monomer is preferably a vinyl monomer having an amide group or a tertiary amino group. Examples of such nitrogen-containing vinyl monomers include N,N-dimethylacrylamide, N-isopropylacrylamide, N,N-dimethylaminoethyl (meth)acrylate, N,N-dimethylaminopropylacrylamide, 2-vinylpyridine, 4-vinylpyridine, and 1-vinylimidazole, and combinations thereof.

At the copolymerization with the alkyl (meth)acrylate, the nitrogen-containing vinyl monomer may be copolymerized at any suitable ratio including, e.g., from about 0.1 parts by weight to about 20 parts by weight.

In preparing the nitrogen-containing (meth) acrylic copolymer, polystyrene can be grafted to the (meth) acrylic copolymer using any suitable method. One useful method includes copolymerizing a styrene macromer. A useful method of synthesizing a styrene macromer is described in detail in Japanese Unexamined Patent Publication (Kokai) No. 59-75975 and incorporated herein. One example of a useful styrene macromer is the styrene macromer commercially available under the trade designation “Macromonomer AS-6S” from Toagosei Chemical Industry Co., Ltd. (Tokyo, Japan).

Examples of vinyl monomers having a reactive functional group on the side chain thereof that are useful in the preparation of the nitrogen-containing (meth) acrylic copolymer include carboxyl group-containing vinyl monomers (e.g., acrylic acid, methacrylic acid, itaconic acid and maleic acid, and acid anhydrides thereof), and hydroxyl group-containing vinyl monomers (e.g., 2-ethylhexyl acrylate and 2-ethylhexyl methacrylate). A crosslinking reaction site can be imparted to the (meth) acrylic resin composition by this vinyl monomer having a polar group (e.g., a carboxyl group, hydroxyl group, and combinations thereof), a vinyl group having a photoreactive group such as acryloylbenzophenone, and combinations thereof.

The polymerization mixture can also include a crosslinking agent. Useful crosslinking agents include, e.g., polyfunctional epoxy compounds, polyfunctional melamine compounds, polyfunctional isocyanate compounds, metal-based crosslinking agents, and polyfunctional aziridine compounds. Crosslinking can be induced by radiation including, e.g., ultraviolet and electron beam radiation, with or without the presence of a crosslinking agent.

The first and second portions of the pressure-sensitive adhesive composition can be mixed at various ratios to form the adhesive composition in any suitable ratio from about 5:95 to about 95:5 (based on solid content), or even from about 25:75 to about 90:10.

The layer of pressure-sensitive adhesive composition disposed on the first surface of the backing can have any suitable thickness including, e.g., from about 0.6 mils to about 40 mils (about 0.015 mm to about 1.0 mm), less than 4 mils, no greater than about 3.5 mils, no greater than about 3 mils, or even from about 1 mils to about 3 mils. The layer of pressure-sensitive adhesive composition can be continuous or discontinuous (e.g., dots, geometric shapes, lines, and swirls, in a pattern or randomly throughout the layer).

The Second Pressure-Sensitive Adhesive Composition

The stretch releasing pressure-sensitive adhesive article optionally includes a second layer of pressure-sensitive adhesive composition disposed on a second major surface of the backing opposite the first major surface of the backing on which the first pressure-sensitive adhesive composition is disposed. The second pressure-sensitive adhesive composition can be in direct contact with the foam layer or disposed on the optional polymer film layer, which is in turn disposed on the foam layer. FIG. 5 illustrates an article 58 that includes a pressure-sensitive adhesive article 60 bonded to a first substrate 62 and a second substrate 64 through a first pressure-sensitive adhesive composition 66 and a second pressure-sensitive adhesive composition 68, respectively. The stretch releasing pressure-sensitive adhesive article 60 includes a backing 70 that includes a layer of foam 72 and a layer of polymer film 74 disposed on a major surface of the layer of foam 72, a first layer of pressure-sensitive adhesive composition 66, which is in direct contact with the layer of foam 72, and a second layer of pressure-sensitive adhesive composition 68, which is disposed on the layer of polymer film 74.

The second layer of pressure-sensitive adhesive composition is preferably selected to be suitable for bonding a desired substrate in a variety of forms including, e.g., sheet materials (e.g., paper including photographs, posters, and pictures), films, woven and nonwoven webs, hanging devices (e.g., injection molded back plate of a hook structure and clips), art, and combinations thereof. The desired substrate can be made from a variety of materials including, e.g., polymers (e.g., plastic), cellulose (e.g., paper), fibers, wood, ceramic, metal, composites (e.g., cellulose (e.g., wood) and polymer composites, polymer and metal composites, polymer and fiber composites), and combinations thereof.

Examples of suitable pressure-sensitive adhesive compositions suitable for the second layer of pressure-sensitive adhesive include the pressure-sensitive adhesive compositions described above, and the pressure-sensitive adhesive compositions described in U.S. Pat. Nos. 6,569,521, 6,403,206, 6,231,962 and 5,516,581, all of which are incorporated herein.

The second pressure-sensitive adhesive layer is of any suitable thickness including, e.g., from about 0.6 mils to about 40 mils (about 0.015 to about 1.0 mm), or even from about 1 mils to about 16 mils (about 0.025 to about 0.41 mm). The second layer of pressure-sensitive adhesive can be continuous or discontinuous (e.g., dots, geometric shapes, lines, and swirls, in a pattern or randomly throughout the layer).

### Release Liner

The stretch releasing pressure-sensitive adhesive article can optionally include at least one liner disposed on the exposed surface of a layer of pressure-sensitive adhesive composition to protect the adhesive composition until use. Examples of suitable liners include, e.g., paper (e.g., kraft paper), polymer films (e.g., polyethylene, polypropylene and polyester), and combinations thereof. At least one surface of the liner can include a release agent resulting from a release treatment to form a release liner. Examples of useful release agents include silicone, silicone copolymers including, e.g., silicone acrylates, silicone polyurethanes and silicone polyureas, fluorochemicals, fluorosilicones, perfluoropolyethers, urethanes, acrylates, polyolefins, low density polyethylene, and other low surface energy-based release compositions, and combinations thereof. Suitable release liners and methods for treating liners are described in, e.g., U.S. Pat. Nos. 4,472,480, 4,980,443 and 4,736,048, all of which are incorporated herein. An example of a useful release liner is a fluoroalkyl silicone polycoated paper.

Liners can include various markings and indicia including, e.g., lines, brand indicia, and other information.

### Tab

The tab of the stretch releasing pressure-sensitive adhesive article can exist in a variety of forms. In one embodiment, the tab is a portion of the backing that is free of pressure-sensitive adhesive composition. In other embodiments, the tab includes a cover layer that is adhered to and covers over the pressure-sensitive adhesive composition. In another embodiment, the tab is a separate component that is affixed to an end portion of the backing. In another embodiment, the tab is created by detackifying the pressure-sensitive adhesive composition using any suitable method including, e.g., applying powder (e.g., baking powder (i.e., calcium carbonate) and titanium dioxide), exposure to radiation (e.g., ultraviolet light), over coating with varnish or ink, and combinations thereof.

### Method of Manufacture

The stretch releasing pressure-sensitive article can be formed using any suitable method for preparing pressure-sensitive adhesive articles including, e.g., coating an adhesive composition directly on a foam substrate, forming an adhesive layer (e.g., by coating onto a release liner) and subsequently laminating the adhesive layer to a foam backing, coextruding, and combinations thereof. Examples of useful methods of making stretch releasing pressure-sensitive adhesive article constructions are described in U.S. Pat. Nos. 6,569,521, 6,403,206, 6,001,471 and 5,516,581 and PCT Publication No. WO 2005/059055, all of which are incorporated herein.

To improve adhesion of the pressure-sensitive adhesive composition to the backing, the backing can be pretreated prior to applying (e.g., coating, laminating, and combinations thereof), the adhesive composition on the backing. Examples of suitable treatments include corona discharge, plasma discharge, flame treatment, electron beam irradiation, ultraviolet (UV) radiation, acid etching, chemical priming, and combinations thereof. The treatment can optionally be performed with a reactive chemical adhesion promoter including, e.g., hydroxyethylacrylate, hydroxyethylmethacrylate, another reactive species having a low molecular weight, and combinations thereof.

### Use

The stretch releasing pressure-sensitive adhesive article is well suited for use on textured surfaces. Textured surfaces can be characterized by a topographical map that includes a number of three dimensional features including, e.g., peaks and valleys. The features may be in the form of a variety of shapes including, e.g., raised masses of indefinite shape, valleys of indefinite shape, elongated bodies extending across at least a portion of the sample including, e.g., elongated bodies having opposed polygonal faces (e.g., triangle, square and rectangular faces), elongated bodies having at least one curved surface, and elongated bodies having indefinite shapes, and curved (s-curve, round, and spiral pattern) and linear (e.g., horizontal and vertical) elongated bodies, shapes that approximate polyhedrons (cube, prism, pyramidal, tetrahedron, pentahedron, hexahedron, octahedron, parallel piped (e.g., rhombohedron) and diamond), and hemispherical, conical, frustoconical, and spherical shapes, and combinations thereof. The features can terminate in an apex having a variety of shapes including, e.g., rounded, sharp, truncated, flat, and irregular termination surfaces. The textured surface can include shapes that are continuous, discontinuous, and combinations thereof. The features can also form a pattern, exhibit random location, and combinations thereof. The spacing of the features can also occur at regular intervals, irregular intervals, and combinations thereof. The features can protrude from a surface, extend into a surface, and combinations thereof.

Textured surfaces can exist on a variety of textured substrates including, e.g., wallpaper (e.g., plasticized vinyl wallpaper (e.g., polyvinyl chloride wallpaper), paper wallpaper, foam backed wallpaper, and combinations thereof), wood, gravel, asphalt, glass, ceramic, brick, stone, cement (e.g., cinder block, cement board), fiberglass, plaster, siding (e.g., vinyl, aluminum, and steel), metal, polymeric, woven fabrics, nonwoven webs, and combinations thereof. The texture can be present due to a variety of sources including, e.g., processing techniques (e.g., embossing, engraving, spraying, printing, cutting, and carving), manufacturing techniques, e.g., weaving, spiral spray, melt blown, coating, molding, and stressing.

The stretch releasing pressure-sensitive adhesive article can be used in a variety of constructions and a variety of applications including, e.g., (1) mounting applications on surfaces such as painted wallboard, plaster, concrete, glass, ceramic, fiberglass, metal or plastic, wall hangings, organizers, holders, baskets, containers, decorations, e.g., holiday decorations, calendars, posters, dispensers, wire clips, body side molding on vehicles, carrying handles, signage applications, e.g., road signs, vehicle markings, transportation markings, and reflective sheeting; (2) joining and assembly applications including, e.g., adhering at least two containers, e.g., boxes, for later separation; (3) cushioning and sound deadening applications including, e.g., cushioning materials for placement beneath objects, sound insulative sheet materials, and combinations thereof; (4) closure applications including, e.g., container closures, e.g., box closures, closures for food containers, closures for beverage containers, diaper closures, and surgical drape closures; (5) vibration damping; (6) sealing applications, e.g., gaskets, for liquids, vapors (e.g., moisture), and dust; (7) thermal insulation; (8) labeling, e.g., removable labels including, e.g., notes, price tags, and identification labels on containers, and signage; (9) medical applications (e.g., bandages, medical device labeling (e.g., in hospital settings) wound care); (10) fastening applications, e.g., fastening one object, e.g., a vase, to another object, e.g., a table or a book shelf; (11) securing applications, e.g., fastening one or more components of a locking mechanism to a substrate, e.g., a child safety lock to a cabinet or cupboard; (12) tamper indicating applications (e.g., tamper indicating articles); and (13) wire and cord organizers, holders, and clips. The stretch releasing pressure-sensitive adhesive article can also be incorporated in a variety of other constructions including, e.g., abrasive articles (e.g., for sanding), articles for sanding and polishing applications (e.g., buffing pads, disc pads, hand pads, and polishing pads), pavement marking articles, and carpeting (e.g., backing for carpeting).

The stretch releasing pressure-sensitive adhesive article can be provided in any useful form including, e.g., tape, sheet (e.g., perforated sheet), roll, disc, and kit (e.g., an object for mounting and the stretch releasing pressure-sensitive adhesive article). Multiple stretch releasing pressure-sensitive adhesive articles can be provided in any suitable form including, e.g., sheet (e.g., perforated sheet), kit, stack, tablet, and combinations thereof in any suitable package including, e.g., dispenser, bag, box, and carton.

A variety of objects can be used to mount articles on the stretch releasing pressure-sensitive adhesive article including, e.g., hooks, separable connector systems, examples of which are described in U.S. Pat. No. 6,972,141 and incorporated herein, and combinations thereof. Suitable hook configurations for use in combination with a stretch releasing pressure-sensitive adhesive article for mounting applications are described in U.S. Pat. No. 5,507,464 and U.S. Des. Pat. Nos. D386,067 and D480,292, all of which are incorporated herein.

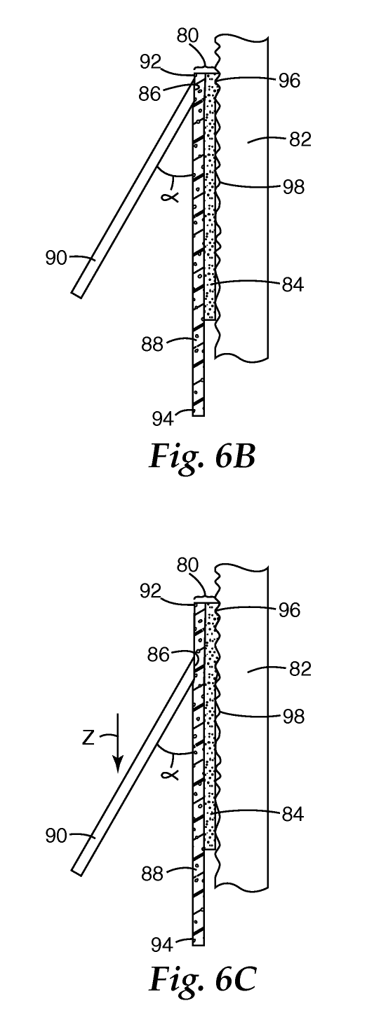

The stretch releasing pressure-sensitive adhesive article can be applied to a surface of a substrate using any suitable method. One useful method includes contacting a surface of a first substrate (e.g., a wall) with the first layer of pressure-sensitive adhesive composition of the stretch releasing pressure-sensitive adhesive article, applying pressure along the length of the article (e.g., applying a static force, applying a dynamic force (e.g., moving a force up and down the length of the article), and combinations thereof), optionally removing a release liner, where present, to expose a second pressure-sensitive adhesive composition, where present, and optionally contacting the second pressure-sensitive adhesive composition with an object (e.g., a hook, sheet (e.g., paper, polymer film, and woven and nonwoven webs), separable connector, and combinations thereof), and applying pressure to bond the object to the second pressure-sensitive adhesive composition. FIGS. 6A-C illustrate a method of applying a stretch releasing pressure-sensitive adhesive article 80 to a textured wall surface 82 in which the wall 82 is first contacted with the first pressure-sensitive adhesive composition 84, a sharp edge 86 of a plastic rectangular plate 90 is then pressed against the backing 88 of the stretch releasing pressure-sensitive adhesive article at an angle α to the backing 88, and the sharp edge 86 is then drawn down the longitudinal extent of the backing 88 from a first end 92 of the backing 88 toward a second end 94 of the backing 88 in the direction of the arrow Z. The sharp edge 86 applies direct pressure against the article 80 so as to achieve point contact between the pressure-sensitive adhesive composition 84 and the features, e.g., protrusions 96 and valleys 98, of the textured wall surface 82. Although the method illustrated in FIGS. 6A-C involves the application of pressure using an edge 86 of a plastic rectangular plate 90, the pressure could be applied with the edge of any suitable rigid applicator tool including, e.g., rigid planar article (e.g., a rectangular, square, or angled plate) made from of a variety of rigid materials including, e.g., polymer (e.g., plastic), metal, wood, and stone.

Another useful method of applying the stretch releasing pressure-sensitive article to a surface includes heating (e.g., increasing the temperature using an oven, a hot air gun or a hair dryer, e.g., directing the flow of warm or hot air output from a hair dryer) the stretch releasing pressure-sensitive article, the first pressure-sensitive adhesive composition of the stretch releasing pressure-sensitive adhesive article, the surface or a combination thereof prior to contacting the surface with the pressure-sensitive adhesive composition of the stretch releasing pressure-sensitive article. In one embodiment, the method includes heating the first pressure-sensitive adhesive composition of the stretch releasing pressure-sensitive adhesive article, contacting the surface with the heated pressure-sensitive adhesive composition of the stretch releasing pressure-sensitive article, applying pressure along the length of the article (e.g., applying a static force, applying a dynamic force (e.g., moving a force (e.g., a roller or a rigid plate) up and down the length of the article), and combinations thereof), optionally removing a release liner, where present, to expose a second pressure-sensitive adhesive composition, where present, and optionally contacting the second pressure-sensitive adhesive composition with an object, and applying pressure to bond the object to the second pressure-sensitive adhesive composition. The heating can occur prior to, during, or after contacting the first substrate with the pressure-sensitive adhesive composition. The method can optionally include heating at least one of the second pressure-sensitive adhesive composition and an object prior to, during, or after contacting the second pressure-sensitive adhesive composition with the object.

The invention will now be described by way of the following examples. Unless indicated to the contrary, all amounts are in percent by weight.

### EXAMPLES

### Test Procedures

Test procedures used in the examples include the following.

### Surface Roughness Test Method

Surface roughness is determined according to ASME B46.1-2002 entitled, “Surface Texture (Surface Roughness, Waviness and Lay),” using a DEKTAK 8 stylus profiler (Veeco Instruments, Woodbury, N.Y.) over an area of 127,000 μm (microns) by 127,000 μm utilizing a stylus with a 12.5 μm radius and 7 mg (milligram) of pressure. The range of the profiler in the z direction is 1 mm. One thousand profiles are recorded per sample and each profile scan lasts 9 seconds. A sampling of 4.704 μm in the x direction and 12.7 μm in the y direction were used. The reported roughness parameter values are calculated based on the values measured over the entire sample area. The data is corrected by performing a tilt term removal using WYKO VISION 3.44 software (Veeco).

Ra, the average roughness over the entire measured sample area, Rq, the root mean square roughness over the entire measured sample area, and Rz, the average of the ten greatest peak to valley separations over the entire measured sample area, are calculated as set forth in ASME B46.1-2002.

### Application Methods

Rolling Pressure

A surface is contacted with the pressure-sensitive adhesive layer of the sample and a 15 lb (6.8 kg) roller is passed over the length of the sample two times at a rate of 12 in/min (30.48 cm/min)

Static Weight

A surface is contacted with the pressure-sensitive adhesive layer of the sample and a 15 pound weight is then placed on top of the sample, so as to sandwich the sample between the weight and the surface. The weight is left on the sample for 30 seconds and then removed.

Rigid Applicator

A surface is contacted with the pressure-sensitive adhesive layer of the sample and a planar edge of a rigid plastic applicator is pressed against the exterior surface of a sample and pressure is vigorously applied along the length of the exterior surface of the sample from one edge of the sample to the opposite edge of the sample, to press the pressure-sensitive adhesive composition into contact with the substrate surface.

### % Surface Contact Test Method

A sample prepared by adhering a stretch releasing pressure-sensitive adhesive (PSA) article to a substrate according the Rigid Applicator application method is conditioned for 30 minutes on dry ice and immediately thereafter slit with a razor to reveal a cross-section region of the PSA-substrate interface. The cross-section region is viewed through a FLEXBAR OPTI-FLEX VISION SYSTEM (Flexbar Machine Corp., Islandia, N.Y.) equipped with VISIONGAUGE video microscope software (VISIONx Inc., Pointe-Claire, Quebec, Canada). The cross-section field of view is measured and the PSA-substrate interface is digitally imaged. The percent surface contact of the stretch releasing pressure-sensitive adhesive article to the substrate surface is calculated by measuring the length of the sample PSA-substrate interface in the field of view and the length of the non-contact regions in the sample, summing the length of the non-contact regions, and subtracting the sum of the length of the non-contact regions from the measured length of the sample in the field of view. Multiple field of view measurements are recorded to measure the approximate total substrate bond length of the stretch releasing pressure-sensitive adhesive article.

### Static Shear Test Method

Static shear is determined according to the method of ASTM D3654-82 entitled, “Holding Power of Pressure-Sensitive Tapes,” with the following modifications. Test samples having the dimensions 0.75 in (inch)×0.75 in (1.91 cm (centimeter)×1.91 cm) are adhered to the test substrate at 72° F. (i.e., 22° C.) and 50% relative humidity using the Rigid Applicator application method set forth above. A metal vapor coated polyester film having the dimensions 0.75 in×4 in (1.91 cm×10.16 cm) is bonded to one side of the adhesive test sample for the purpose of attaching the load.

The test sample is allowed to dwell on the test substrate for 1 hour at 22° C. and 50% relative humidity; thereafter a 1 kg weight is applied to the metal vapor coated polyester film. The time to failure is recorded in minutes and the average value, calculated pursuant to procedures A and C of section 10.1 of the standard, for all of the test samples is reported. Six samples are tested and the average time to failure of the six samples and the failure mode (where present) of each sample is recorded. A value is reported with a greater than symbol (i.e., >) when at least one of the six samples has not failed at the time the test is terminated.

### Stretch Release Debond Force Test Method

A conventional variable angle peel jig is modified for use with an IMASS adhesion tester (IMASS Inc., Hingham, Mass.) to enable measurement of low angle debond forces for an adhesive article adhered to a test surface. The jig can securely hold a 2 in×12 in (5.08 cm×30.5 cm) substrate. The jig is secured to the IMASS platen. A 0.625 in×2.75 in (1.59 cm×6.99 cm) test sample is adhered to the test substrate to provide a bond area of 0.625 in×2 in (1.59 cm×5.08 cm). The test sample has a 0.625 in×0.75 in (1.59 cm×1.91 cm) non-adhering tab for clamping to the IMASS tester. A 1.59 cm×5.08 cm×0.16 cm high impact polystyrene flat piece is bonded to the side of the test sample opposite the substrate. The test sample is then conditioned for 24 hours under conditions of 50% relative humidity and 22° C. and then debonded at a peel speed of 30 in/min (76.2 cm/min) and at a peel angle of 2°. The average debond force required to stretch the adhesive article for removal from the substrate is recorded in units of ounces per 0.625 in width. A minimum of three measurements are made from each substrate and the results are averaged.

### Clean Removability Test Method

The surface of a substrate is visually inspected and the amount of adhesive residue remaining on the test area of the substrate surface is observed and recorded.

### Surface Damage Test Method

The surface of a substrate is visually inspected and any damage to the test area of the substrate surface is observed and recorded.

### Method of Measuring Caliper

The caliper of a sample is measured using an Ono Soki ST-022 digital gauge. Multiple measurements are taken at random locations across the sample and the average is recorded in units of inches (in).

### Load at Break Test Method

Load at break of a sample is measured according to ASTM D412-92 entitled, “Vulcanized Rubber and Thermoplastic Rubbers and Thermoplastic Elastomers-Tension,” using an INSTRON Tensile Tester (available from Instron Corporation, Canton, Mass.) or other equivalent device.

### Textured Substrates

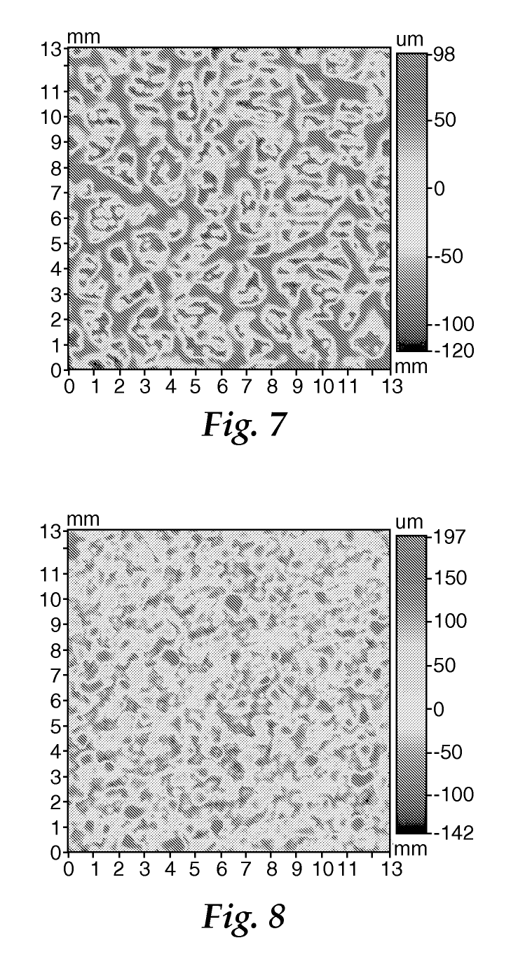

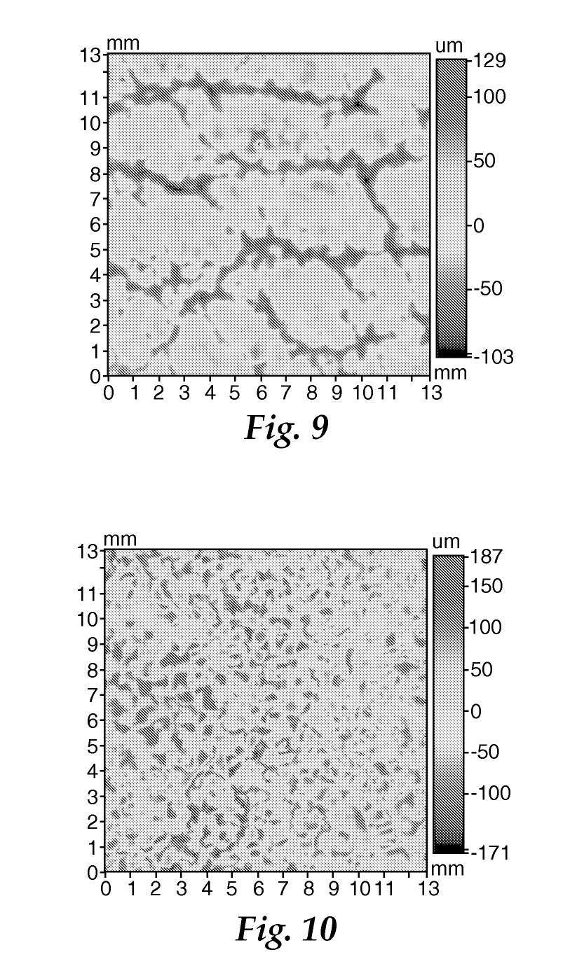

The surface roughness of four different types of textured polyvinyl chloride wallpaper was determined according to the Surface Roughness test method and the results are set forth in Table 1 below in μm (micron). The topographical map of samples 1-4, as generated by the DEKTAK 8 stylus profiler, are shown in FIGS. 7-10, respectively. The color scale corresponds to the height and depth of the surface features in μm.

TABLE 1

| Wallpaper | Ra | Rq | Rz |
|---|---|---|---|
| Sample | (μm) | (μm) | (μm) |
| 1 | 42.17 | 50.21 | 214.18 |
| 2 | 44.72 | 54.34 | 319.49 |
| 3 | 28.03 | 33.68 | 200.67 |
| 4 | 46.77 | 57.82 | 349.94 |

### Preparation of the Pressure-Sensitive Adhesive Transfer Film

A pressure-sensitive adhesive blend was prepared by blending a first pressure-sensitive adhesive composition that included butylacrylate (BA), a methacrylate-terminated polystyrene polymeric monomer prepared according to procedures detailed for monomer “C-2” at column 13, line 40 of U.S. Pat. No. 5,057,366 (STYMAC), vinyl imidazole (VIM) and acrylic acid at a BA/STYMAC/VIM/AA ratio of 69.5/20/10/0.5 that had been polymerized to an inherent viscosity (IV) range of from 1.25-1.40, and a second pressure-sensitive adhesive composition, i.e., described as Composition D in U.S. Pat. No. 6,231,962 (Bries) at a blend ratio of 30:70 with physically mixing. The resulting pressure-sensitive adhesive blend was subsequently coated on a silicone release liner at a target dried coating thickness of 2.75+/−0.2 mils and dried for 10 minutes at 70° C. to produce a pressure-sensitive adhesive transfer film.

### Control 1

Each major surface of a composite foam constructed as a film/foam/film composite foam sheet having a 1.8 mil thick linear low density polyethylene (LLDPE) film (Pliant Corporation) on either side of a 6 pcf polyethylene-vinyl acetate copolymer foam substrate having a thickness of 0.031 inch (Sekisui Voltek LLC) was chemically treated with a chemical primer prepared according to Example 15 of U.S. Pat. No. 5,677,376 (Groves). The pressure-sensitive adhesive transfer film prepared above was then dry laminated to each side of the composite foam backing using a laboratory laminator operating at 12 inches per minute and 25 psi nip pressure to form adhesive laminated sheets to form an adhesive/film/foam/film/adhesive construction.

### Control 2

Each major surface of a composite foam sheet constructed as a film/foam/film composite foam having a 1.8 mil thick linear low density polyethylene (LLDPE) films (Pliant Corporation) on either side of a 4 pcf polyethylene-vinyl acetate copolymer foam substrate having a thickness of 0.044 inch (Sekisui Voltek LLC) was chemically treated with a chemical primer prepared according to Example 15 of U.S. Pat. No. 5,677,376 (Groves). The pressure-sensitive adhesive transfer film prepared above was then dry laminated to each side of the composite foam backing using a laboratory laminator operating at 12 inches per minute and 25 psi nip pressure to form adhesive laminated sheets to form an adhesive/film/foam/film/adhesive construction.

Test strips of Control 2 were bonded to the samples of the textured vinyl wallpaper set forth in Table 1 using the Rolling Pressure application method set forth above. The samples were then tested according to the % Surface Contact test method and the Static Shear test method (with the exception that the samples were applied to the test substrate using the Rolling Pressure application method instead of the Rigid Applicator application method, the sample size was 0.75 in×0.83 in and the load was 3.91 pounds per square inch). The results are reported in Table 2 below.

TABLE 2

| | | Average Static | |
|---|---|---|---|
| | % | Shear of 6 | |
| Wallpaper | Surface | Samples | |
| Sample | Contact | (Minutes) | Failure Mode |
| 1 | 73.6 | >260688 | 6 of 6 had no failures |
| 2 | 23.3 | 117 | 6 of 6 popped off |
| 3 | 85.2 | >233733 | 5 of 6 popped off |
| 4 | 42.0 | 709 | 6 of 6 popped off |

### Examples 1-6

The pressure-sensitive adhesive transfer film prepared above was dry laminated to each side of a number of foam substrates using a laboratory laminator operating at 12 inches per minute and 25 psi nip pressure to form an adhesive laminated sheet. Prior to adhesive lamination, the foam was chemically treated with a chemical primer prepared according to Example 15 of U.S. Pat. No. 5,677,376 (Groves). Test strips were then die-cut from the adhesive laminated sheets.

### Examples 7 and 8

A 1.8 mil XMAX 161.1 linear low density polyethylene film (Pliant Corporation, Chippewa Falls, Wis.) was bonded to a foam substrate to form a composite foam backing. Each major surface of the composite foam backing was chemically treated with a chemical primer prepared according to Example 15 of U.S. Pat. No. 5,677,376 (Groves). The pressure-sensitive adhesive transfer film was then transfer laminated on each side of the composite foam backing using a laboratory laminator operating at 12 inches per minute and 25 psi nip pressure to form adhesive laminated sheets. Test strips were then die-cut from the adhesive laminated sheets.

The density and thickness (which were obtained from the manufacturer) of the foam backings of the test strips of Control 2 and Examples 1-4 are set forth below in Table 3. Test strips prepared according to Control 2 and Examples 1-4 were applied to the vinyl wallpaper sample 2 above and the vinyl wallpaper sample 4 above using the Rigid Applicator application method set forth above. The resulting constructions were then analyzed according to the % Surface Contact to determine the % Surface Contact between the article and the wallpaper sample. The results are reported in Table 3.

TABLE 3

| | | | | | % Surface |
|---|---|---|---|---|---|
| | Foam | Foam | Film | % Surface | Contact |
| | Density | Thickness | Thickness | Contact | Wallpaper |
| | (pcf¹) | (in) | (mil) | Wallpaper 2 | 4 |
| Control 2 | 4 | 0.044 | 1.8 LLDPE² | 26.2 | 37.7 |
| Example 1 | 8 | 0.018 | None | 51.6 | 78.5 |
| Example 2 | 12 | 0.020 | None | 56.1 | 73.9 |
| Example 3 | 15 | 0.012 | None | 43.9 | 74.4 |
| Example 4 | 20 | 0.010 | None | 27.6 | 63.8 |

¹= pounds per cubic foot
²= linear low density polyethylene

Test strips prepared according to Control 1 and Examples 1-3 were applied to vinyl wallpaper sample 2 above using the Rigid Applicator application method set forth above. The resulting constructions were then analyzed according to the % Surface Contact to determine the % Surface Contact between the test strip and the wallpaper sample and tested according to the Static Shear test method. The results are reported in Table 4.

TABLE 4

| | | | | | Static |
|---|---|---|---|---|---|
| | | | | | Shear after |
| | | | | % Surface | Rigid |
| | Foam | Foam | Film | Contact | Applicator |
| | Density | Thickness | Thickness | Wallpaper | application |
| | (pcf) | (in) | (mil) | 2 | (min¹) |
| Control 1 | 6 | 0.035 | 1.8 LLDPE | NT | 16206 |
| Control 2 | 4 | 0.044 | 1.8 LLDPE | 26.2 | 3649 |
| Example 1 | 8 | 0.018 | None | 51.6 | 85376 |
| Example 2 | 12 | 0.020 | None | 56.1 | 36444 |
| Example 3 | 15 | 0.012 | None | 43.9 | 20720 |

1 = minute
NT = not tested

Test strips prepared according to Control 1 and Examples 1, 2, 5, and 6 were applied to vinyl wallpaper sample 2 above using the Static Weight application method set forth above. The resulting constructions were then tested according to the Static Shear test method noting the exception that the samples had been prepared according to the Static Weight application method instead of the Rigid Applicator application method. The results are reported in Table 5.

TABLE 5

| | Foam | Foam | Film | Static Shear |
|---|---|---|---|---|
| | Density | Thickness | Thickness | after Static |
| Sample | (pcf¹) | (in) | (mil) | Weight (min²) |
| Control 1 | 6 | 0.035 | LLDPE³ | 7153 |
| Example 1 | 8 | 0.018 | None | 32712 |
| Example 2 | 12 | 0.020 | None | 9734 |
| Example 5 | 15 | 0.015 | None | 11160 |
| Example 6 | 15 | 0.017 | None | 5233 |

Test strips prepared according to Control 1 and Examples 1, 2, and 5-8 were applied to vinyl wallpaper sample 2 above using the Rigid Applicator application method set forth above. The resulting constructions were then tested according to the Stretch Debond Force test method in the machine direction and the cross direction orientations of the backing. The average stretch debond force in the machine direction and the cross direction orientations of the backing, as well as observations regarding the cleanliness of the test surface after removal, damage to the test surface after removal, and test strip breakage, for each sample is reported in Table 6. Different samples were tested to obtain results for the machine direction orientation of the backing and the cross direction orientation of the backing.

TABLE 6

| | | | | | | Ave. | |
|---|---|---|---|---|---|---|---|
| | | | | | | Stretch | |
| | | | | Ave. Stretch | | Debond | |
| | | | | Debond Force | | Force in | |
| | | | | in Machine | | Cross | |
| | Foam | Foam | Film | Direction | | Direction | |
| | Density | Thickness | Thickness | (oz/0.625 in | | (oz/0.625 | |
| Sample | (pcf) | (in) | (mil) | width) | Observation | in width) | Observation |
| Control 1 | 6 | 0.035 | LLDPE | 96.1 | Clean | 68.8 | Clean |
| | | | | | removal. Strip | | removal. Strip |
| | | | | | did not break. | | did not break. |
| | | | | | No substrate | | No substrate |
| | | | | | damage. | | damage. |
| Example 1 | 8 | 0.018 | None | 53.4 | Clean | 42.4 | Strip broke. |
| | | | | | removal. Strip | | |
| | | | | | did not break. | | |
| | | | | | No substrate | | |
| | | | | | damage. | | |
| Example 2 | 12 | 0.020 | None | 65.1 | Clean | 51.9 | Strip broke. |
| | | | | | removal. Strip | | |
| | | | | | did not break. | | |
| | | | | | No substrate | | |
| | | | | | damage. | | |
| Example 5 | 15 | 0.015 | None | 64.7 | Clean | 53.7 | Clean |
| | | | | | removal. Strip | | removal. Strip |
| | | | | | did not break. | | did not break. |
| | | | | | No substrate | | No substrate |
| | | | | | damage. | | damage. |
| Example 6 | 15 | 0.017 | None | 72.1 | Clean | 64.1 | Clean |
| | | | | | removal. Strip | | removal. Strip |
| | | | | | did not break. | | did not break. |
| | | | | | No substrate | | No substrate |
| | | | | | damage. | | damage. |
| Example 7 | 8 | 0.018 | 1.8 mil | NT | NA | 58.7 | Clean |
| | | | LLDPE | | | | removal. Strip |
| | | | | | | | did not break. |
| | | | | | | | No substrate |
| | | | | | | | damage. |
| Example 8 | 12 | 0.020 | 1.8 mil | NT | NA | 69.1 | Clean |
| | | | LLDPE | | | | removal. Strip |
| | | | | | | | did not break. |
| | | | | | | | No substrate |
| | | | | | | | damage. |

NT = Not Tested.

### Examples 9-11

A 1.8 mil XMAX 161.1 linear low density polyethylene film (Pliant Corporation) was bonded to a foam substrate to form a composite foam backing. Each major surface of the composite foam backing was chemically treated with a chemical primer prepared according to Example 15 of U.S. Pat. No. 5,677,376 (Groves). The pressure-sensitive adhesive transfer film was then transfer laminated on each side of the composite foam backing using a laboratory laminator operating at 12 inches per minute and 25 psi nip pressure to form adhesive laminated sheets to form an adhesive/film/foam/adhesive construction. The adhesive layers were covered with a release liner. Test strips were then die-cut from the adhesive laminated sheets.

The density and thickness (both of which were obtained from the manufacturer) of the foam of the backing of the test strips of Control 1 and Examples 9-11 are set forth in Table 7 below.

The adhesive layer disposed directly on the foam of the test strips of Examples 9-11 was bonded to vinyl wallpaper sample 2 using the Rigid Applicator application method set forth above.

The adhesive layer disposed on a film layer of Control 1 was bonded to vinyl wallpaper sample 2 using the Rigid Applicator application method set forth above.

The resulting constructions of Examples 9-11 and Control 1 were tested according to the Static Shear test method. The results are reported in Table 7.

TABLE 7

| | | | Film | |
|---|---|---|---|---|
| | Density | Thickness | Thickness | Static Shear¹ |
| Example | (pcf) | (inch) | (mil) | (min) |
| Control 1² | 6 | 0.035 | 1.8 | 51793 |
| 9 | 8 | 0.015 | 1.8 | 107711 |
| 10 | 12 | 0.020 | 1.8 | >62929 |
| 11 | 15 | 0.017 | 1.8 | >41993 |

¹= Foam side to wallpaper
²= Control 1 had a film/foam/film backing construction.

All references including the patents and patent applications referred to herein are incorporated herein in total.

Other embodiments are within the claims.

What is claimed is:

1. A method of bonding a stretch releasing pressure-sensitive adhesive article to a surface, the method comprising:
providing a stretch releasing adhesive article, wherein the article exhibits at least 40% surface contact when bonded to a standardized textured surface, the stretch releasing adhesive article comprising:
a backing comprising a continuous layer of foam having a density of from about 7 pounds per cubic foot to about 15 pounds per cubic foot, a caliper of from about 0.01 inch to less than 0.020 inch, a first major surface and a second major surface opposite the first major surface;
a first layer of first pressure-sensitive adhesive composition disposed on the first major surface of the layer of foam and in direct contact with the foam; and
a nontacky tab;
contacting a surface with the first layer of pressure-sensitive adhesive composition, the backing of the article further comprising a first end, a second end opposite the first end and a longitudinal extent extending between the first end and the second end; and
applying pressure along at least a portion of the longitudinal extent of the backing.

2. The method of claim 1, wherein applying pressure comprises
positioning an edge of a rigid applicator tool near the first end of the backing, and
drawing the edge of the rigid applicator tool down the longitudinal extent of the backing toward the second end of the backing while maintaining contact between the rigid substrate and the backing and exerting a force against the backing sufficient to press the adhesive composition into intimate contact with the surface.

3. The method of claim 2, wherein the surface is a textured surface comprising features and the force exerted against the backing is sufficient to press the adhesive composition into intimate contact with the features.

4. The method of claim 2, wherein the surface exhibits a Ra value of at least 40 μm, a Rq value of at least 40 μm, and a Rz value of at least 300 μm over a 12.7 mm by 12.7 mm area of the surface.

5. The method of claim 1, wherein the surface comprises a textured, plasticized vinyl surface.

6. The method of claim 1 further comprising heating at least one of the pressure-sensitive adhesive composition and the surface prior to contacting the surface with the pressure-sensitive adhesive composition.

7. A method of bonding the stretch releasing pressure-sensitive adhesive article to a surface, the stretch releasing pressure-sensitive adhesive comprising:
a backing comprising a continuous layer of foam having a density of from about 7 pounds per cubic foot to about 15 pounds per cubic foot, a caliper of from about 0.01 inch to less than 0.020 inch, a first major surface and a second major surface opposite the first major surface;
a first layer of first pressure-sensitive adhesive composition disposed on the first major surface of the layer of foam and in direct contact with the foam;
a second layer of pressure-sensitive adhesive composition disposed on the second major surface;
a release liner disposed on the second layer of pressure-sensitive adhesive; and
a nontacky tab;
the method comprising:
contacting the surface with the first layer of pressure-sensitive adhesive composition;
applying pressure to the article along at least a portion of a length of the article;
removing the release liner to expose the second layer of pressure-sensitive adhesive composition; and
contacting the second layer of pressure-sensitive adhesive composition with an object.

8. A method of bonding a stretch releasing pressure-sensitive adhesive article to a surface, the method comprising:
contacting the surface with a stretch releasing pressure-sensitive adhesive article comprising a pressure-sensitive adhesive composition, a first end, a second end and a longitudinal extent extending between the first end and the second end;
positioning a planar edge of a rigid applicator tool near the first end of the article; and
drawing the edge of the rigid applicator tool down the longitudinal extent of the article toward the second end of the article while maintaining contact between the edge of the rigid applicator tool and the article and exerting a force against the article sufficient to press the pressure-sensitive adhesive composition into intimate contact with the surface.

9. The method of claim 8, wherein the surface comprises the surface of a textured plasticized vinyl substrate and exhibits a Ra value of at least 40 μm, a Rq value of at least 40 μm, and a Rz value of at least 300 μm over a 12.7 mm by 12.7 mm area of the surface.

10. The method of claim 8 further comprising heating at least one of the pressure-sensitive adhesive composition and the surface prior to contacting the surface with the pressure-sensitive adhesive composition.
